(19) United States
(12) Patent Application Publication
(10) Pub. No.: US 2007/0282750 A1
(43) Pub. Date: Dec. 6, 2007

(54) DISTRIBUTING QUASI-UNIQUE CODES THROUGH A BROADCAST MEDIUM

(76) Inventor: Daniel P. Homiller, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/421,322

(22) Filed: May 31, 2006

(51) Int. Cl. H04L 9/00

(52) U.S. Cl. 705/52

(57) ABSTRACT

Disclosed is a system and method for allowing a multimedia content provider to verify that a particular item of multimedia content has been rendered on a particular device, without the need to provide differentiated copies of the multimedia content. The method comprises: receiving a multimedia signal at a rendering device, wherein the multimedia signal includes an embedded code; extracting the embedded code from the multimedia signal; processing the embedded code with a device identification associated with the rendering device through a hash algorithm to obtain an end user code; and presenting the end user code in a user sensible format. The user sensible format may be visual, as viewed by an associated user on a display, or audible output from a speaker.

### TECHNICAL FIELD OF THE INVENTION

The present invention relates to a system and method for distributing quasi-unique codes through a broadcast medium.

### DESCRIPTION OF THE RELATED ART

Advertising is the promotion of goods, services, companies and ideas, usually by an identified sponsor. Commercial advertising media can take a variety of forms including, for example, television and radio commercials, billboards, newspapers, web banners, magazines, the opening section of streaming audio and video content, previews on digital video disks, compact disks and videocassettes, and the like. The television commercial is generally considered the most effective mass-market advertising format and this is reflected by the high prices television networks charge for commercial airtime during popular television events.

Over the years, the public perception of advertising has become negative. Advertising is often seen as a medium that inherently promotes misinformation in order to encourage the target audience to submit to a cause or a belief and act on it to the advertising party's benefit and consequently the target's disadvantage. Advertisements are generally perceived as stating opinions or untruths directly as to facts, omitting to tell the target audience key information needed to successfully use the product and/or services, portraying a product and/or service in a light that does not reflect reality or even making up realities where their product and/or service has a new role.

Not surprisingly, due to this perception, technology has been developed to allow the consumer to skip broadcast advertisements. In the broadcast video arena, technology such as, for example, digital video recorders (DVRs), TiVo, Replay TV, and the like allow the consumer to skip commercials that are interspersed throughout a television program, for example.

In order to combat user apathy towards television advertisements, advertisers have begun making interactive commercials. For example, one fast food chain created a television advertisement to entice DVR users to actually spend time interacting with the commercial, rather than simply skipping past the commercial. The advertisement included a “secret code” that could only be read by viewing the commercial using a conventional frame by frame advance function provided on the DVR. Once known, the secret code could be redeemed at the fast food restaurant's web site for a coupon for a free fast food item.

One problem associated with this advertising strategy is that the same secret code is broadcast to millions of viewers simultaneously. There is no mechanism to prevent one user from reading the secret code, and then communicating the secret code to others that did not actually view the advertisement. While in some instances the fast food restaurant may actually desire the secret code to be passed to others that did not view the advertisement in order to have additional people come into their restaurant to redeem the coupon, it may be desirable in many instances to actually enforce the requirement that each interested individual actually interact with the broadcasted material. For example, a large cash prize will likely draw even more attention than a coupon for a fast food item, but the number of winners must obviously be limited.

### SUMMARY

The present invention overcomes the shortcomings of the prior art by providing a system and method to effectively distribute unique secret codes to viewing devices, even over a broadcast bearer. By this system and method, the multimedia content provider is able to verify that a particular item of multimedia content has been rendered on a particular device.

One aspect of the present invention relates to a method to allow a content provider to verify that a particular item of content has been rendered on a device, the method comprising: receiving a multimedia signal at a rendering device, wherein the multimedia signal includes an embedded code; extracting the embedded code from the multimedia signal; processing the embedded code with a device identification associated with the rendering device through a hash algorithm to obtain an end user code; and presenting the end user code in a user sensible format.

Another aspect of the invention relates to an electronic rendering device comprising: at least one memory for storing an electronic device identification associated with the electronic rendering device and a hash algorithm; an interface for receiving a multimedia signal, wherein the multimedia signal includes an embedded code; a processor coupled to the interface and the memory, wherein the processor combines the electronic device identification and the embedded code and processes the combination through the hash algorithm to create an end user code; and an output device coupled to the processor for outputting the end user code in a user sensible format.

According to another aspect of the present invention, a program stored on a machine readable medium is provided, the program being suitable for use in a electronic rendering device wherein; when the program is loaded in memory in the electronic rendering device and executed, causes extracting an embedded code from a multimedia signal; processing the embedded code with a device identification associated with the electronic rendering device through a hash algorithm to obtain an end user code; and presenting the end user code in a user sensible format.

According to another aspect, the code is embedded in metadata associated with the multimedia signal.

According to another aspect, the embedded code is encrypted.

According to another aspect, the device identification is electronically stored a memory of the rendering device.

According to another aspect, the device identification is selected from the group consisting of a serial number associated with the rendering device or a telephone number associated with the rendering device.

According to another aspect, the embedded code and the device identification are combined prior to processing through the hash algorithm to obtain the end user code.

According to another aspect, the hash algorithm is selected from the group consisting of: MD2, MD4, MD5, SHA-1, SHA-2, SHA-256, SHA-384, SHA-512, RIPEMD-128, RIPEMD-160, RIPEMD-256, RIPEMD-320, PANAMA or TIGER.

According to another aspect, the rendering device is a digital video recorder.

According to another aspect, the rendering device is a portable communication device.

According to another aspect, the step of presenting the end user code is visually displayed on a display associated with the rendering device.

According to another aspect, the step of presenting the end user code is audibly output through a speaker associated with the rendering device.

According to another aspect, the invention further comprises authenticating the end user code at an associated remote server.

According to another aspect, the step of authentication comprises: an associated user entering the end user code and the device identifier on an associated Internet website for authentication by the associated remote server.

According to another aspect, the rendering device is one selected from the group consisting of a digital video recorder, a cellular telephone, a MP-3 player, or a videocassette player.

According to another aspect, the output device is a display communicatively coupled to the electronic rendering device.

According to another aspect, the output device is a speaker communicatively coupled to the electronic rendering device.

According to another aspect, the output device is housed integrally with the electronic rendering device.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary block diagrams of communication systems in accordance with aspects of the present invention.

FIG. 3 is an exemplary block diagram of a mobile telephone in accordance with aspects of the present invention.

FIG. 4 is an exemplary schematic diagram of a mobile telephone in accordance with aspects of the present invention.

FIG. 5 is an exemplary flow chart of a method in accordance with aspects of the present invention.

### DETAILED DESCRIPTION OF EMBODIMENTS

The present invention provides a system and method to allow a multimedia content provider to verify that a particular item of multimedia content has been rendered on a particular device, without the need to provide differentiated copies of the multimedia content. Since broadcast and/or distributed copying is much more efficient than providing individualized content blocks, there are many potential applications for the present invention. For example, the present invention is applicable to a wide variety of media (e.g., television, digital multimedia content, radio, streaming video, streaming audio, DVD's, CD's, videocassettes, and the like). The present invention provides a system and method for proving or verifying (also referred to herein as “authenticating”) that a particular item of multimedia content, available either by broadcast or by distribution of undifferentiated copies, was viewed (rendered) by a particular device.

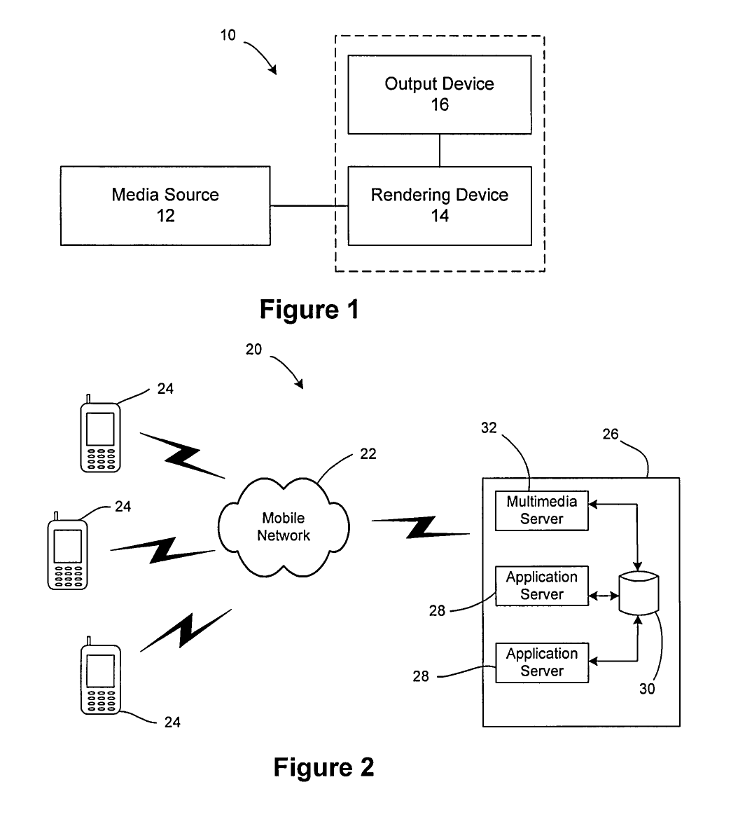

Referring to FIG. 1, an exemplary communication system 10 is shown. The communication system 10 includes a multimedia source 12, a rendering device 14, and an output device 16. The multimedia source 12 may be any source of media. For example, the media source 12 may include a broadcast media in the form of an analog or digital television signal, an analog or digital audio signal, steaming video, streaming audio, radio, satellite radio, a DVD, a CD, a videocassette and the like. The rendering device 14 may be any type of device that is capable of rendering multimedia in a format that is directly perceptible to the user and/or that requires another device to decode the signal to be perceptible to the user. Exemplary rendering devices include, for example, DVRs, DVD players, CD players, MP3 players, cellular telephones, videocassette players, radios, satellite radio receivers, etc. The output device 16 may be any type of device that is capable of outputting received signals in a user sensible format. For example, the output device 16 may be a television, a computer display, a cell phone display, a speaker, a light emitting diode, etc. One of ordinary skill in the art will readily appreciate that a user sensible format may include, for example, an image, text, an audible indication, etc. One of ordinary skill will also appreciate that the playback device 14 may be combined with the output device 16 in an integral unit, as illustrated by the dashed-lines in FIG. 1.

While the above example illustrates an application directed to broadcast television, the invention is especially adaptable to multi-mode devices, e.g. electronic equipment such as mobile radio terminals equipped with television/video decoding abilities. For example, as shown in FIG. 2, the communication system 20 includes a mobile network 22, such as a mobile cellular telephony network, that facilitates communication, such as voice communication and/or data transfer between a plurality of mobile radio terminals 24, such as portable communication devices, mobile phones, satellite radio receivers, and the like. The communication system 20 includes a network infrastructure 26, portions of which are used or otherwise accessed by the mobile radio terminals in connection with aspects of the invention. The mobile radio terminals 24 may interact with each other and/or the network infrastructure in accordance with any suitable communication standard, including, but not limited to, Advanced Mobile Phone Service (AMPS), Digital Advanced Mobile Phone Service (D-AMPS), Global System for Mobile Communications (GSM), Code Division Multiple Access (CDMA) or the like. In other words, the communication system is shown in FIG. 2 for purposes of explaining aspects of the present invention, without limiting the invention to a particular communication system design, architecture or communication standard.

The network infrastructure 26 includes one or more application servers, which are indicated generally by the numeral 28, and a storage device 30, such as a memory for storing data accessible or otherwise usable by the application servers 28. At least one of the application servers is a multimedia server 32. The multimedia server 32 is capable of broadcasting multimedia content through the mobile network 22 to one or more mobile radio terminals 24. The application servers 28, including the multimedia server 32, are computer servers that may serve one or more different functions in the communication system.

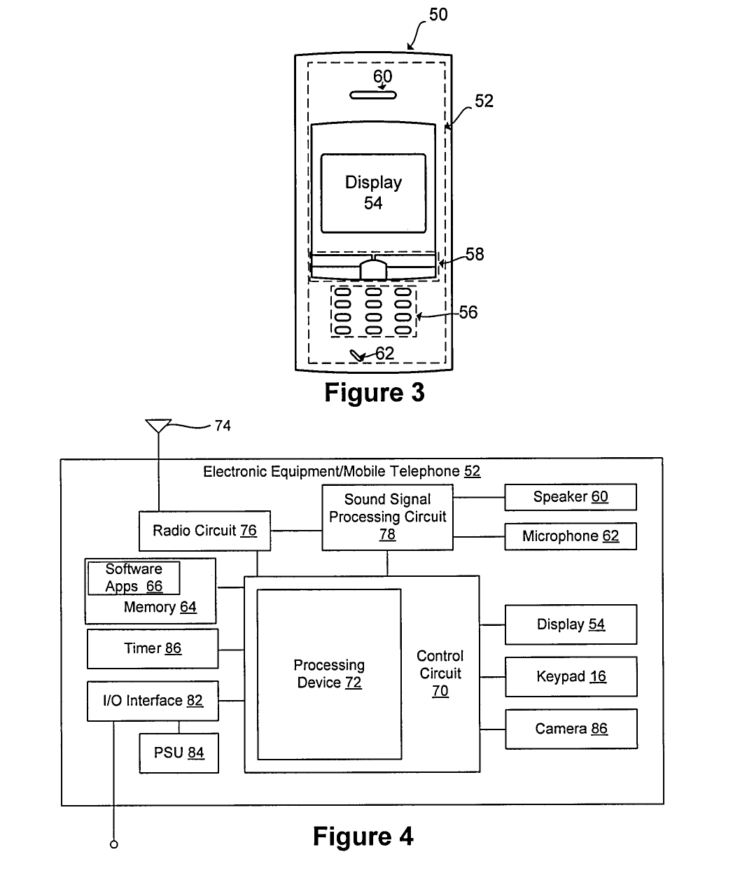

Referring to FIG. 3, exemplary electronic equipment 50 is shown in accordance with aspects of the present invention. The electronic equipment 50 in the exemplary embodiment is a mobile telephone and will be referred to as the mobile telephone 50. The mobile telephone 50 is shown as having a “brick” or “block” design type housing, but it will be appreciated that other type housings, such as clamshell housing or a slide-type housing, may be utilized without departing from the scope of the invention.

As illustrated in FIG. 3, the electronic equipment 50 may include a user interface 52 (identified by dotted lines) that enables the user easily and efficiently to perform one or more communication tasks (e.g., identify a contact, select a contact, make a telephone call, receive a telephone call, display end-user codes, audibly listen to end-user codes, etc.) The user interface 52 of the electronic equipment 50 generally includes one or more of the following components: a display 54, an alphanumeric keypad 56, function keys 58, a navigation tool 59, a speaker 60, and a microphone 62.

The mobile telephone 50 includes a display 54. The display 54 displays information to a user such as operating state, time, telephone numbers, contact information, various navigational menus, status of one or more functions, etc., which enable the user to utilize the various features of the mobile telephone 50. The display 54 may also be used to visually display content accessible by the mobile telephone 50, as well as display end-user codes in accordance with aspects of the present invention. The displayed content may include E-mail messages, audio and/or video presentations stored locally in memory 64 (FIG. 4) of the mobile telephone 50 and/or stored remotely and download to the mobile telephone 50 (e.g., from a remote storage device, a mail server, remote personal computer, etc.). Such presentations may be derived, for example, from multimedia files stored on a remote web server, received through E-mail messages, etc. The multimedia files may include any type of multimedia content (e.g., video, audio, graphics, songs, movies, television broadcasts, radio broadcasts, satellite radio broadcasts, etc.) The audio component of such presentations, including an end-user code, may be broadcast to the user with speaker 60 of the mobile telephone 50. Alternatively, the audio component may be broadcast to the user though a headset speaker (not shown).

The mobile telephone 50 further includes a keypad 56 that provides for a variety of user input operations. For example, the keypad 56 may include alphanumeric keys for allowing entry of alphanumeric information such as user-friendly identification of contacts, E-mail addresses, distribution lists, telephone numbers, phone lists, contact information, notes, etc. In addition, the keypad 56 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 54 to select different telephone functions, profiles, settings, etc., as is conventional. Other keys associated with the mobile telephone 50 may include a volume key, audio mute key, an on/off power key, a web browser launch key, an E-mail application launch key, a camera key, etc. Keys or key-like functionality may also be embodied as a touch screen associated with the display 54.

The mobile telephone 50 also includes conventional radio and signal processing circuitry that enables the mobile telephone 50 to establish a call, transmit and/or receive E-mail messages, download multimedia content and/or exchange signals with a remote device, typically another mobile telephone or landline telephone. However, the remote device need not be another telephone, but may be some other electronic device such as an Internet web server, E-mail server, content providing server, etc.

Referring to FIG. 4, a functional block diagram of the mobile telephone 50 is illustrated. The mobile telephone 50 includes a primary control circuit 70 that is configured to carry out overall control of the functions and operations of the mobile telephone 50. The control circuit 70 may include a processing device 72, such as a CPU, microcontroller or microprocessor. The processing device 72 executes code stored in a memory (not shown) within the control circuit 70 and/or in a separate memory, such as memory 64, in order to carry out operation of the mobile telephone 50. The processing device 72 is generally operative to execute computer code to perform all of the functionality disclosed herein.

The memory 64 may be any suitable memory device. For example, the memory 64 may be, for example, random access memory, read only memory, a buffer, a flash memory, a hard drive, a removable media, a volatile memory and/or a non-volatile memory. In order to carry out the various functions described herein, the memory 24 may include one or more computer application 66 (or sub-applications) to achieve the functionality described herein. For example, as detailed below, computer application 66 may include computer code for: extracting a coded embedded in multimedia content and performing a hash algorithm.

Continuing to refer to FIGS. 3 and 4, the mobile telephone 10 includes an antenna 74 coupled to a radio circuit 76. The radio circuit 76 includes a radio frequency transmitter and receiver for transmitting and receiving signals via the antenna 74 as is conventional. The mobile telephone 50 generally utilizes the radio circuit 76 and antenna 74 for voice, Internet and/or E-mail communications over a cellular telephone network. The mobile telephone 50 further includes a sound signal processing circuit 78 for processing the audio signal transmitted by/received from the radio circuit 36. Coupled to the sound processing circuit 78 are the speaker 60 and a microphone 62 that enable a user to listen and speak via the mobile telephone 60 as is conventional. The radio circuit 76 and sound processing circuit 78 are each coupled to the control circuit 70 so as to carry out overall operation. Although the invention is described utilizing the radio circuit 76 for receiving the multimedia content, one of ordinary skill in the art will readily appreciate that the multimedia content may also be downloaded to the mobile telephone (or other electronic device) through other interfaces including, for example, 802.11 compatible interfaces, WiMax, Bluetooth, etc., assuming the mobile telephone (or other electronic equipment) has the appropriate interface adapter.

The mobile telephone 50 also includes the aforementioned display 54 and keypad 56 coupled to the control circuit 70. The mobile telephone 50 further includes an I/O interface 82. The I/O interface 82 may be in the form of typical mobile telephone I/O interfaces, such as a multi-element connector at the base of the mobile telephone 50. As is typical, the I/O interface 82 may be used to couple the mobile telephone 50 to a battery charger to charge a power supply unit (PSU) 84 within the mobile telephone 50. In addition, or in the alternative, the I/O interface 82 may serve to connect the mobile telephone 50 to a wired personal hands-free adaptor, to a personal computer or other device via a data cable, etc. The mobile telephone 50 may also include a timer 86 for carrying out timing functions. Such functions may include timing the durations of calls, generating the content of time and date stamps, etc.

The mobile telephone 50 may include various built-in accessories, such as a camera 86 for taking digital pictures. Image files corresponding to the pictures may be stored in the memory 64. In one embodiment, the mobile telephone 50 also may include a position data receiver (not shown), such as a global positioning satellite (GPS) receiver, Galileo satellite system receiver or the like.

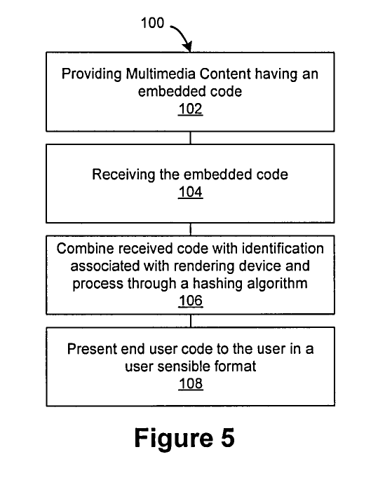

An exemplary method 100 in accordance with the invention is illustrated in FIG. 5. At step 102, multimedia content is provided with an embedded code. Generally, due to the efficiencies associated with broadcast communications a unique code cannot be sent to each rendering device. Instead, a single code (herein referred to as the “master code” and/or “code”) is embedded in the multimedia content. The master code may be embedded in the multimedia content in any desirable manner. The sole requirement regarding embedding the code is that an appropriate rendering device can recognize the code and extract it. Exemplary methods of embedding the master code in the multimedia content include, for example, embedding the master code in a file header, embedding the master code in a format that permits the inclusion of metadata associated with the multimedia object. One of ordinary skill in art will readily appreciate that the master code may also be distributed with analog multimedia content. Exemplary techniques for distributing data along with analog content include the provision of a digitally modulated subcarrier signal, such as is used with FM radio systems by the Radio Data System (RDS) and Radio Broadcast Data System; or the superpositioning of digital data on a portion of the signal that is not rendered into a user sensible format, such as is done for closed captioning information on conventional television broadcasts.

Preferably, the multimedia data format provides a technique for embedding the master code in such a way that it is associated with a particular time or range of times in the playback of the multimedia content. In this way, the master code may be only operable for a brief period of time. In addition, for some applications, it might be desirable to encrypt the master code so that it cannot be separated easily from the multimedia content outside the rendering device. As one of ordinary skill in the art will appreciate, this encryption might be in conjunction with encryption of the multimedia content itself, or it might be performed independently.

At step 104, a rendering device capable of recognizing the master code receives the multimedia content having the embedded master code provided from step 52. As stated above, the rendering device may receive the multimedia content from any suitable interface (e.g., cellular radio circuit 76, WLAN adapter, Bluetooth adapter, etc.) The rendering device extracts the master code and processes it in a predetermined manner, as set forth below.

At step 106, the master code is combined with a device identifier. The device identifier can be any type of identifier that is capable of identifying at least one attribute associated with the device. Exemplary device identifiers may include a device serial number, model number, phone number, contact name, manufacturer name, etc. The resulting combination is processed using a hash algorithm. Any hash algorithm may be used in accordance with the present invention. Exemplary hash algorithms include MD2, MD4, MD5, SHA-1, SHA-2, SHA-256, SHA-384, SHA-512, RIPEMD-128, RIPEMD-160, RIPEMD-256, RIPEMD-320, PANAMA, TIGER and/or a combination thereof. The result of this step may be a unique or a quasi-unique code (the “end-user code”) dependent on the rendering device and the hash algorithm. One of ordinary skill in the art will readily appreciate that extraction and processing of the embedded code and/or device identifier may occur in one or more computer programs and/or subprograms 66 located in memory 64.

At step 108, the end user code is presented to the end user in a user sensible format. The user sensible format may be visual, audible and/or combination of visual and audible formats. For example, a video player rendering device might be programmed to display a numeric code superimposed on the video image, or even formatted within a special field of the video image to display the end user code. The end user code may be designed to correspond to alphanumeric characters, so that the display could be of alphanumeric characters. The end user code may also be converted into speech that may be played through an audio output. One of ordinary skill in the art will readily appreciate that presentation of the end user code may be in any suitable manner that allows the end user a way to access the end user code and the precise details may depend on the application.

The hash algorithm is effectively a one-way function. A value is processed by the hash program and another value is output. In many cases, even if the precise details of the hash algorithm are known, it is effectively impossible to obtain the input value based solely on the output value of the hash algorithm. The effect of combining the master code with a device identifier is to generate a more-or-less unique output from the hash algorithm that has at least two desirable characteristics: (1) it provides little or no information about the master code, and (2) it provides an easy means for someone with knowledge of the master code to verify that it has been processed by a particular device.

For example, the prior art fast food advertisement described above could be enhanced and implemented using the present invention in the following manner. This example assumes that the electronic devices (e.g., DVRs, mobile telephones, etc.) are suitably programmed to extract the master code embedded in the multimedia content, to combine the master code with a device-specific identifier, and to process the resulting combination with a suitable hash algorithm as set forth above. Viewers A and B are watching the same multimedia content on separate televisions having separate enabled-DVRs. The multimedia content embedded with a master code is processed separately by the enabled-DVRs, each having a different device identifier. Each of the enabled-DVRs processes the master code and its device identifier through a hash algorithm, and the corresponding end user codes are displayed on Viewer A's and Viewer B's televisions. Instead of being identical, the end user codes are distinct.

Viewers A and B may now be asked to access a website associated with the advertisement. The viewers are prompted to enter the end-user code that was displayed on their enabled-DVR, as well as the device identifier associated with their enabled-DVR. As one of ordinary skill in the art will appreciate, the device identifier could be the viewer's phone number (which is programmed into the enabled-DVR so that it be automatically accessed by the algorithm), a portion of the enabled-DVR serial number, or any other more-or-less unique number that is stored in the enabled-DVR for use by the hash algorithm. The associated website server application, which has knowledge of the master code, can simply repeat the process that was performed on the viewer's enabled-DVR (e.g., combine the master code with the device identifier and process the combination through the hash algorithm). If the result matches the end-user code that was reported by the viewer, a match is determined. If the result is different than the reported end-user code, no match is determined.

If the advertiser is concerned about viewers sharing the viewer's unique data (e.g., the viewer's end user code, device identifier, telephone number, etc.) with others, the application server can be programmed to reject future inquiries that supply an identical device identification number. Thus, each applicant to advertiser's website must have actually viewed the multimedia content on his or her own rendering device.

The combination of the master code with the device identifier may be obtained by any desirable technique. For example, the combination may be performed by simply concatenating the master code and the device identifier, although any number of mathematical or numerical methods may be used. Optionally, the combination may further include “padding,” i.e. the concatenation or insertion of known digits or bits to produce a resulting combination with a desired length. Other much more complicated combinations might also be desirable to optimize two characteristics of the hash algorithm that might be of varying importance depending on the particular application. The first characteristic is the irreversibility of the process. Some hash algorithms are inherently harder to reverse than others, although it is generally true that for any given hash output, there are a number of inputs that could have produced it. This is especially true if the input length is variable—then potentially an infinite number of inputs can produce a given output. This characteristic might be more or less important depending on how much value the user of this system places on keeping the master code absolutely secret. The second characteristic is the apparent “randomness” of the output. Since multiple inputs can produce the same output, there is some chance that the televisions of two different viewers will display exactly the same end-user codes, even though different device-specific identifiers are used. The likelihood of this occurrence can be adjusted by careful selection of the hash algorithm and the technique used for combining the master code with the device identifier. Many applications may not require a very low rate of duplicate outputs. Even if there are duplicate outputs the authentication process described above is unaffected. For example, as each viewer accesses the associated website and enters his end-user code and individual device identifier number, the advertiser's application server will determine whether the entered information is a match thus authenticating each viewer properly, even when multiple devices output the same end-user code. If another person who has not viewed the multimedia content, attempts to submit the same end-user code, but along with his or her own device identifier (e.g., serial number, phone number, etc.), he or she will most likely fail the authentication process.

The problem that someone might guess a device identifier that will combine with the master code to yield the correct end user code is substantially reduced. This probability can easily be reduced to negligible dimensions depending on the application by appropriate choice of the hash algorithm and combination technique.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method to allow a content provider to verify that a particular item of content has been rendered on a device, the method comprising:
receiving a multimedia signal at a rendering device, wherein the multimedia signal includes an embedded code;
extracting the embedded code from the multimedia signal;
processing the embedded code with a device identification associated with the rendering device through a hash algorithm to obtain an end user code;
presenting the end user code in a user sensible format.

2. The method of claim 1 wherein, the code is embedded in metadata associated with the multimedia signal.

3. The method of claim 1, wherein the embedded code is encrypted.

4. The method of claim 1, wherein the device identification is electronically stored in a memory of the rendering device.

5. The method of claim 4, wherein the device identification is selected from the group consisting of a serial number associated with the rendering device or a telephone number associated with the rendering device.

6. The method of claim 1, wherein the embedded code and the device identification are combined prior to processing through the hash algorithm to obtain the end user code.

7. The method of claim 6, wherein the hash algorithm is selected from the group consisting of: MD2, MD4, MD5, SHA-1, SHA-2, SHA-256, SHA-384, SHA-512, RIPEMD-128, RIPEMD-160, RIPEMD-256, RIPEMD-320, PANAMA or TIGER.

8. The method of claim 1, wherein the rendering device is a digital video recorder.

9. The method of claim 1, wherein the rendering device is a portable communication device.

10. The method of claim 1, wherein the step of presenting the end user code comprises visually presenting the end user code on a display associated with the rendering device.

11. The method of claim 1, wherein the step of presenting the end user code comprises audibly presenting the end user code through a speaker associated with the rendering device.

12. The method of claim 1 further comprising authenticating the end user code at an associated remote server.

13. The method of claim 12, wherein the step of authentication comprises: entering of the end user code and the device identifier by an associated user on an associated Internet website for authentication by the associated remote server.

14. The method of claim 1, wherein the rendering device is one selected from the group consisting of a digital video recorder, a cellular telephone, a MP-3 player, or a videocassette player.

15. An electronic rendering device comprising:
at least one memory for storing a hash algorithm and an electronic device identification associated with the electronic rendering device;
an interface for receiving a multimedia signal, wherein the multimedia signal includes an embedded code;
a processor coupled to the interface and the memory, wherein the processor combines the electronic device identification and the embedded code and processes the combination through the hash algorithm to create an end user code;
an output device coupled to the processor for outputting the end user code in a user sensible format.

16. The electronic rendering device of claim 15, wherein the electronic device identification is selected from the group consisting of a serial number associated with the rendering device or a telephone number associated with the rendering device.

17. The electronic rendering device of claim 16, wherein the processor combines the embedded code and processes the combination through the hash algorithm to obtain the end user code.

18. The electronic rendering device of claim 15, wherein the hash algorithm is selected from the group consisting of: MD2, MD4, MD5, SHA-1, SHA-2, SHA-256, SHA-384, SHA-512, RIPEMD-128, RIPEMD-160, RIPEMD-256, RIPEMD-320, PANAMA or TIGER.

19. The electronic rendering device of claim 15, wherein the electronic rendering device is a digital video recorder.

20. The electronic rendering device of claim 15, wherein the electronic rendering device is a portable communication device.

21. The electronic rendering device of claim 15, wherein the output device is a display communicatively coupled to the electronic rendering device.

22. The electronic rendering device of claim 15, wherein the output device is a speaker communicatively coupled to the electronic rendering device.

23. The electronic rendering device of claim 15, wherein the output device is housed integrally with the electronic rendering device.

24. A program stored on a machine readable medium, the program being suitable for use in a electronic rendering device wherein;
when the program is loaded in memory in the electronic rendering device and executed, causes extracting an embedded code from a multimedia signal;
processing the embedded code with a device identification associated with the electronic rendering device through a hash algorithm to obtain an end user code;
presenting the end user code in a user sensible format.

25. The program of claim 24, wherein the electronic rendering device is a digital video recorder.

26. The program of claim 24, wherein the electronic rendering device is a portable communication device.
